(19) United States
(12) Patent Application Publication
(10) Pub. No.: US 2013/0246535 A1
(43) Pub. Date: Sep. 19, 2013

(54) SYSTEM, METHOD, AND COMPUTER PROGRAM PRODUCT FOR CONDITIONALLY RESTRICTING AN ASPECT OF AN ELECTRONIC MESSAGE BASED ON THE EXISTENCE OF A PREDETERMINED DATA STRUCTURE

(71) Applicants: Amit Kumar Yadava, Bangalore (IN); Harish Chakkingal, Bangalore (IN)

(72) Inventors: Amit Kumar Yadava, Bangalore (IN); Harish Chakkingal, Bangalore (IN)

(21) Appl. No.: 11/939,453

(22) Filed: Nov. 13, 2007

(51) Int. Cl. G06F 15/16

(52) U.S. Cl. 709/206

(57) ABSTRACT

A system, method, and computer program product are provided for conditionally restricting an aspect of an electronic message based on the existence of a predetermined data structure. In use, an electronic message is received. In addition, it is determined whether the electronic message includes a predetermined data structure. Furthermore, an aspect of the electronic message is conditionally restricted based on the determination, for preventing data leakage.

### FIELD OF THE INVENTION

The present invention relates to data leakage prevention, and more particularly to preventing data leakage associated with electronic messages.

### BACKGROUND

Data leakage prevention systems have traditionally been utilized for preventing unwanted disclosure of data. For example, the data leakage prevention systems have generally restricted unauthorized access to and/or communication of confidential data. However, traditional data leakage prevention systems have customarily exhibited various limitations, particularly with respect to data leakage associated with electronic messages.

For example, electronic messages containing confidential information are sometimes purposefully or inadvertently communicated to one or more recipients who are not authorized to receive such confidential information. This communication may therefore result in the compromise of commercial data, the exposure of personal data, or other undesired situations. As another example, traditional data leakage prevention systems have conventionally relied on fingerprint pattern matching techniques for detecting potential leakage of confidential information, which has been burdensome on mobile devices capable of sending and/or receiving electronic messages. In particular, the processing power and storage capabilities of mobile devices are generally limited, thus causing inefficient and/or ineffective data leakage prevention on such mobile devices.

There is thus a need for addressing these and/or other issues associated with the prior art.

### SUMMARY

A system, method, and computer program product are provided for conditionally restricting an aspect of an electronic message based on the existence of a predetermined data structure. In use, an electronic message is received. In addition, it is determined whether the electronic message includes a predetermined data structure. Furthermore, an aspect of the electronic message is conditionally restricted based on the determination, for preventing data leakage.

### DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for conditionally restricting an aspect of an electronic message based on the existence of a predetermined data structure, in accordance with one embodiment.

FIG. 4 shows a system for conditionally restricting an aspect of an electronic message based on the existence of a predetermined data structure, in accordance with another embodiment.

FIG. 5 shows a method for conditionally adding a protection header to an electronic message, in accordance with yet another embodiment.

FIG. 6 shows a method for conditionally restricting access to an electronic message, in accordance with yet another embodiment.

### DETAILED DESCRIPTION

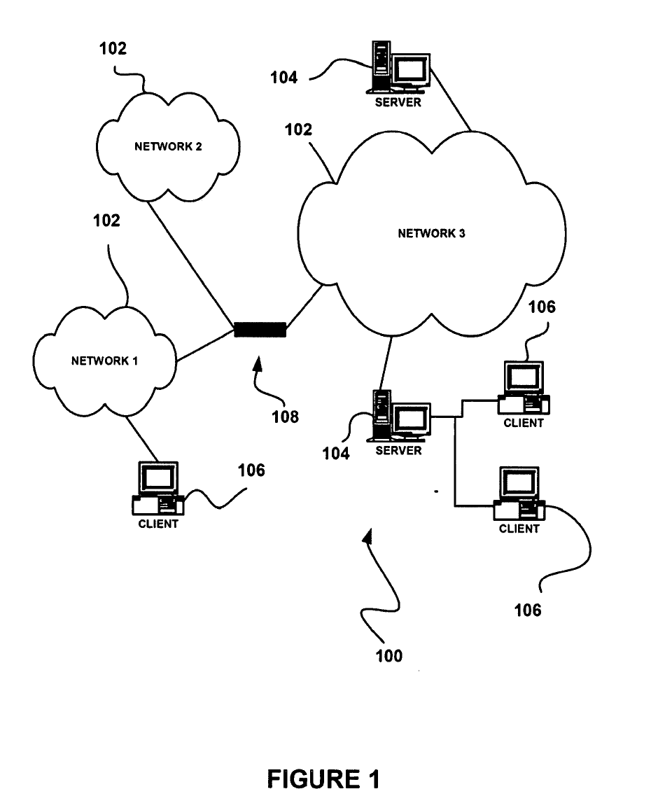

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

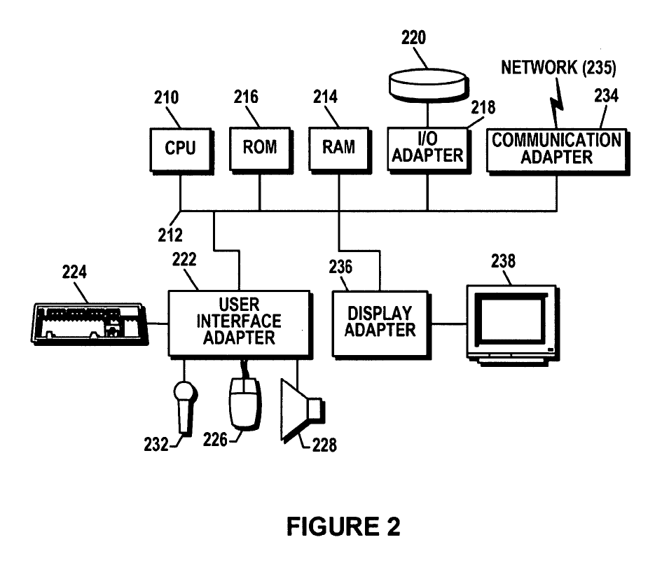

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof For that matter, any type of logic may be utilized which is capable of implementing the various functionality set forth herein.

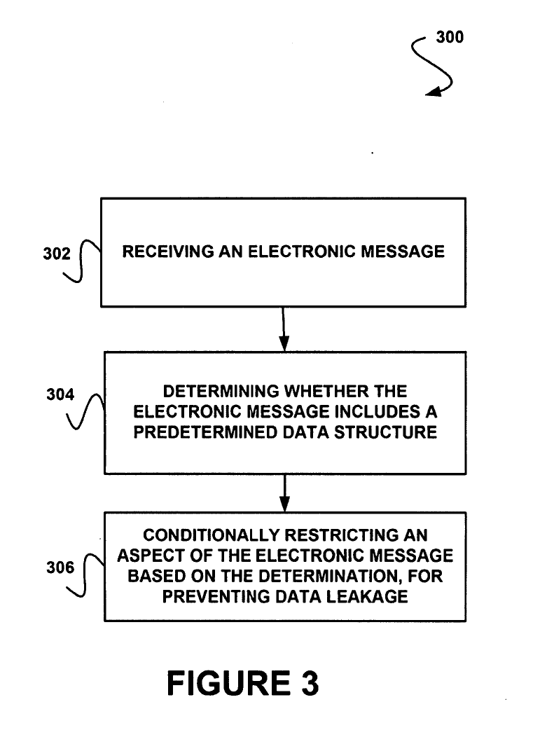

FIG. 3 shows a method 300 for conditionally restricting an aspect of an electronic message based on the existence of a predetermined data structure, in accordance with one embodiment. As an option, the method 300 may be carried out in the context of the details of FIGS. 1 and/or 2. Of course, however, the method 300 may be carried out in any desired environment. Further, the aforementioned definitions may equally apply to the description below.

As shown in operation 302, an electronic message is received. In one embodiment, the electronic message may include an electronic mail message. Of course, however, the electronic message may include any other message capable of being communicated electronically. For example, the electronic message may include a short message service (SMS) message, a multimedia messaging service (MMS) message, etc.

Additionally, the electronic message may be received in any manner. In one embodiment, the electronic message may be received from a source of the electronic message. Optionally, such source may include a device (e.g. such as any of the devices described above with respect to FIGS. 1 and/or 2) that initiated communication of the electronic message. For example, the electronic message may be pushed by the source of the electronic message. In another example, the electronic message may be pulled from the source of the electronic message. In still another example, the electronic message may be forwarded by the source of the electronic message.

As another option, the electronic message may be received from a security system (e.g. data leakage prevention system, etc.). Just by way of example, the security system may intercept the electronic message during communication of the electronic message from the source. In one embodiment, the security system may be located on a network over which the electronic message is communicated.

In yet another example, the electronic message may be received using a wireless protocol. For example, the electronic message may be received using a Bluetooth® protocol, an SMS protocol, an MMS protocol, a cellular protocol, an Institute of Electrical and Electronics Engineers (IEEE) 802.11 protocol, an infrared transfer protocol, etc.

Still yet, the electronic message may be received by any device capable of receiving an electronic message. Just by way of example, the electronic message may be received by a mobile device, a data leakage prevention system of the mobile device, etc. Further, the electronic message may be received over a network, such as a network on which such device is located.

Additionally, in operation 304, it is determined whether the electronic message includes a predetermined data structure. In one embodiment, the predetermined data structure may be added to the electronic message by a security system, such as the security system described above. In another embodiment, the predetermined data structure may be added to the electronic message, only if the electronic message is determined to include predetermined data (e.g. confidential data, etc.).

In yet another embodiment, the data structure may include a header. For example, the data structure may include a multipurpose Internet mail extension (MIME) header. In another example, the data structure may include an encrypted header. Of course, however, the data structure may include an attachment, a flag, a fingerprint, or any other data structure capable of being included in or associated with the electronic message.

In still another embodiment, the data structure may indicate that the electronic message contains a particular type of data. For example, as noted above, the data structure may indicate that the electronic message contains confidential information. As another option, the data structure may include at least a portion of a body of the electronic message. For example, the data structure may include one or more keywords from the body of the electronic message.

Moreover, the determination of operation 304 may be made by parsing all or part of the electronic message. For example, at least a portion of the electronic message may be parsed in order to determine whether the electronic message contains the predetermined data structure. In another embodiment, the determination may be made by comparing at least a portion of the electronic message against one or more predetermined data structures. For example, a header may be extracted from the electronic message and compared against a list of predetermined headers indicating confidential information. Of course, however, the determination may be made in any manner.

Optionally, the determination of whether the electronic message includes the predetermined data structure may be made by a mobile device, such as the mobile device by which the electronic message is received, as described above. As another option, such determination may be performed by the data leakage prevention system located on the mobile device or in communication therewith.

Furthermore, in operation 306, an aspect of the electronic message is conditionally restricted based on the determination in order to prevent data leakage. Optionally, restricting the aspect of the electronic message may include preventing, blocking, etc. such aspect, at least in part. Of course, however, the restriction may include any restriction capable of preventing data leakage with respect to the electronic message.

In one embodiment, the aspect may include access to at least a portion of the electronic message. For example, the aspect may include modification to at least a portion of the electronic message, such as the content of the electronic message, a display of at least a portion of the electronic message (e.g. via a display device, etc.), a deletion of at least a portion of the electronic message, generation of a copy of at least a portion of the electronic message, etc. In this way, access to at least a portion of the electronic message may be restricted in order to prevent data leakage.

In another embodiment, the aspect may include a transfer (e.g. communication, etc.) of at least a portion of the electronic message, such that a transfer of at least a portion of the electronic message may be restricted. For example, the aspect may include communication of an electronic mail message including all or part of the electronic message, storage of all or part of the electronic message, communication of a text message including all or part of the electronic message, forwarding of all or part of the electronic message, printing of all or part of the electronic message, etc. Of course, it should also be noted that the aspect may also include generation of an electronic mail message, text message, etc. which includes at least a portion of the electronic message.

Additionally, in one embodiment, the aspect of the electronic message may be restricted if it is determined that the electronic message includes the predetermined data structure. For example, the ability to transfer all or part of the electronic message (e.g. via Bluetooth®, SMS, etc.) may be disallowed if it is determined the electronic message contains a header indicating that the electronic message contains confidential information. However, in another embodiment, the aspect of the electronic message may not be restricted if it is determined that the electronic message does not include the predetermined data structure. Optionally, the mobile device, such as the data leakage prevention system of the mobile device, may conditionally restrict the aspect of the electronic message.

Accordingly, leakage of data associated with the electronic message may be prevented if it is determined that the message includes a predetermine header indicating that the electronic message includes confidential data, in accordance with one embodiment. In the context of the present description, the data leakage may include any undesired, unauthorized, etc. communication of data. For example, the data leakage may include the unauthorized communication of confidential data. In various embodiments, the data leakage may be unintentional or intentional. In this way, the existence of the predetermined data structure may limit the time and/or resources consumed in preventing data leakage, in one optional embodiment.

More illustrative information will now be set forth regarding various optional architectures and uses in which the foregoing method may or may not be implemented, per the desires of the user. It should be strongly noted that the following information is set forth for illustrative purposes and should not be construed as limiting in any manner. Any of the following features may be optionally incorporated with or without the exclusion of other features described.

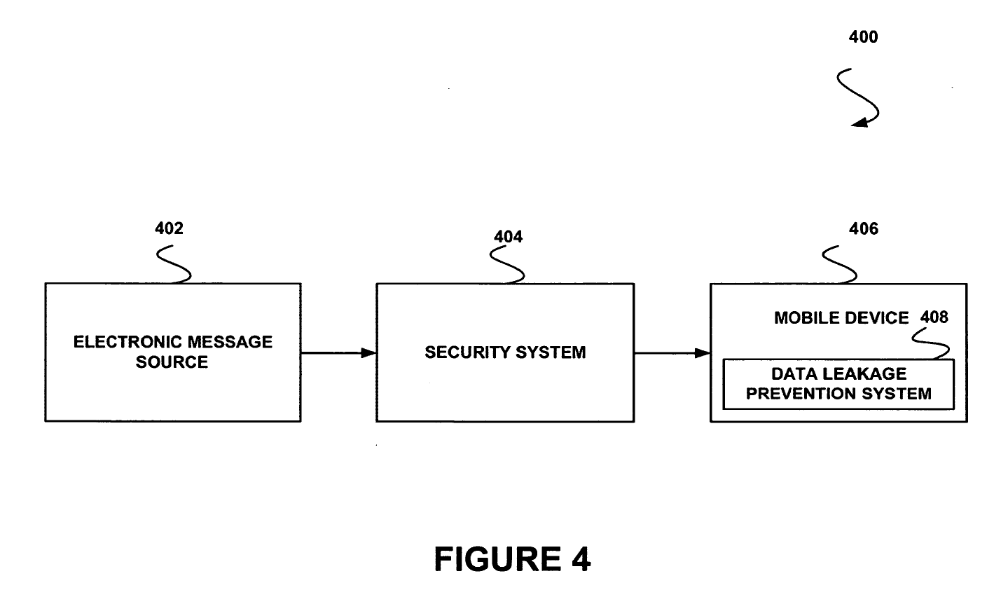

FIG. 4 shows a system 400 for conditionally restricting an aspect of an electronic message based on the existence of a predetermined data structure, in accordance with another embodiment. As an option, the system 400 may be implemented in the context of the details of FIGS. 1-3. Of course, however, the system 400 may be implemented in any desired environment. It should also be noted that the aforementioned definitions may apply during the present description.

As shown, an electronic message source 402 is in communication with a security system 404 (e.g. via a network, etc.). In the context of the present embodiment, the electronic message source 402 may include any source of one or more electronic messages. As an option, the electronic message source 402 may include any of the servers 104 and/or clients 106 illustrated in FIG. 1.

In one embodiment, the electronic message source 402 may create the electronic message and send it to the security system 404. For example, the electronic message source 402 may include an application for creating electronic messages (e.g. such as an electronic mail message application, etc.). In another embodiment, the electronic message source 402 may receive the electronic message (e.g. from another device, etc.) and forward the electronic message to the security system 404.

In yet another embodiment, the security system 404 may intercept the electronic message during communication of the electronic message from the electronic message source 402. Just by way of example, the electronic message may be destined for a mobile device 406. Of course, however, the electronic message source 402 may send the electronic message to the security system 404 in any manner.

Thus, the security system 404 may receive the electronic message from the electronic message source 402. In response to receipt of the electronic message, the security system 404 may determine whether the electronic message includes predetermined data (e.g. confidential data, etc.). In one embodiment, the security system 404 may parse the electronic message received from the electronic message source 402 for determining whether any portion of the electronic message includes the predetermined data. In another embodiment, the security system 404 may scan the electronic message in order to determine whether the electronic message includes the predetermined data.

As an option, the security system 404 may compare data identified from within the electronic message (e.g. via the parsing, etc.) with predetermined data (e.g. data predetermined to be confidential, keywords predetermined to indicate confidential data, etc.). If a match is found, the electronic message may be determined to include the predetermined data. Further, the security system 404 may add a predetermined data structure to the electronic message if it is determined the electronic message includes the predetermined data. Such predetermined data structure may indicate that the electronic message includes the predetermined data, in one embodiment. For example the security system 404 may add a header to the electronic message. In another example, the security system 404 may add a protection header to the electronic message that indicates that the electronic message contains confidential information.

In still yet another embodiment, the security system 404 may include an application that runs in the background of a system. For example, the security system 404 may continuously search for recently received electronic messages and may parse new electronic messages when they are found. In another embodiment, the security system 404 may include a network gateway. Of course, however, the security system 404 may include any of the servers 104 and/or clients 106 illustrated in FIG. 1. Optionally, the security system 404 may include a data leakage prevention system.

Additionally, the security system 404 is in communication with a mobile device 406. As an option, the mobile device 406 may include any of the mobile clients 106 illustrated in FIG. 1. Of course, however, the mobile device 406 may include any device that is mobile and further capable of receiving electronic messages.

In one embodiment, the mobile device 406 may receive the electronic message from the security system 404. For example, the electronic message received by the security system 404 from the electronic message source 402 may be forwarded to the mobile device 406. As also shown, the mobile device 406 includes a data leakage prevention system 408.

In one embodiment, the data leakage prevention system 408 may include software running on the mobile device 406. For example, the data leakage prevention system 408 may include a plug-in for the mobile device 406. In another embodiment, the data leakage prevention system 408 may include hardware coupled to the mobile device 406. Further, the data leakage prevention system 408 may have access to electronic message resources on the mobile device 406. For example, the data leakage prevention system 408 may be in communication with an electronic mail message application located on the mobile device 406.

To this end, the data leakage prevention system 408 may identify the electronic message received by the mobile device 406 from the security system 404. The data leakage prevention system 408 may also analyze such electronic message. For example, the data leakage prevention system 408 may parse the electronic message. In this way, the data leakage prevention system 408 may determine whether the electronic message includes the predetermined data structure.

In yet another embodiment, the data leakage prevention system 408 may perform an action based on the determination. Such action may include conditionally restricting an aspect of the electronic message based on the determination in order to prevent data leakage. For example, if the data leakage prevention system 408 determines that the electronic message includes the predetermined data structure indicating that the electronic message includes predetermined data, the aspect of the electronic message may be restricted to the mobile device 406. Optionally, such aspect may include printing, saving, copying, etc. the electronic message or any portion thereof. As another example, if the data leakage prevention system 408 determines that the electronic message does not include the predetermined data structure, the aspect of the electronic message may not necessarily be restricted.

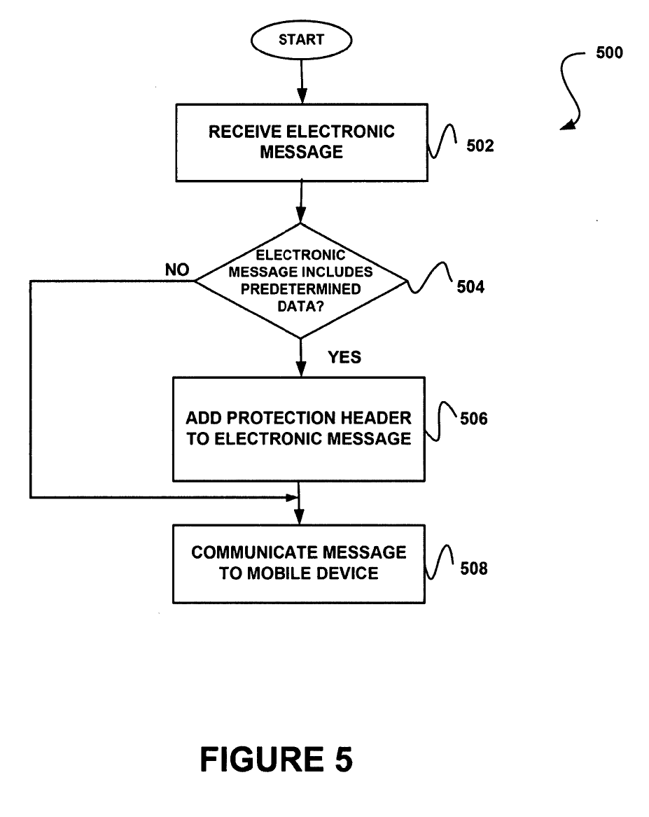

FIG. 5 shows a method 500 for conditionally adding a protection header to an electronic message, in accordance with yet another embodiment. As an option, the method 500 may be carried out in the context of the architecture and environment of FIGS. 1-4. For example, the method 500 may be carried out utilizing the security system 404 of FIG. 4. Of course, however, the method 500 may be carried out in any desired environment. Again, it should be noted that the aforementioned definitions may apply during the present description.

As shown in operation 502, an electronic message is received. In one embodiment, the electronic message may be received via a network. In another embodiment, the electronic message may be received by a data leakage prevention system located on the network. Further, the electronic message may be received from a source of the electronic mail message. Of course, however, the electronic message may be received in any manner.

Additionally, in decision 504, it is determined whether the electronic message includes predetermined data. In the context of the present embodiment, the predetermined data may include any data that has been predefined. For example, the predetermined data may include data predetermined to be confidential with respect to a company, a network, etc. Thus, the predetermined data may include confidential data.

In another embodiment, one or more portions of the electronic message may be analyzed in order to determine whether the electronic message includes the predetermined data. For example, a body of the electronic message may be scanned for one or more predetermined keywords. In another example, a title of the electronic message may be analyzed for determining whether the title includes any words, phrases, etc. matching the predetermined data.

In yet another embodiment, one or more signatures, fingerprints, hashes, etc. may be generated from any portion of the electronic message. For example, the signature, etc. may be generated utilizing one or more keywords found in the body of the electronic message. Further, the signature, etc. generated from the electronic message may be compared against a database of predetermined data. For example, it may be determined that the electronic message includes the predetermined data if a match is found between the generated signature and a signature included in such database.

If it is determined in decision 504 that the electronic message includes the predetermined data, a protection header is added to the electronic message. Note operation 506. In the context of the present embodiment, the protection header may include any message header used in protecting against data leakage. For example, the protection header may indicate that the electronic message includes the predetermined data.

In one embodiment, the protection header may include some or all of the data in the electronic message. For example, the protection header may include some or all of the predetermined data. In another example, the protection header may include one or more keywords found in the electronic message.

In another embodiment, the protection header may include a predetermined message. For example, the protection header may include a notification that the message contains the predetermined data. In another example, the protection header may include instructions describing one or more actions to take to protect against data leakage. Just by way of example, the protection header may indicate restrictions to be placed on the electronic message. In still another embodiment, the protection header may include a MIME header. In yet another embodiment, the protection header may include a fingerprint.

Additionally, in operation 508, the electronic message is communicated to a mobile device. The mobile device may include a device designated as the destination of the electronic message by a source of the electronic message. As also shown, if it is determined in decision 504 that the electronic message does not include predetermined data, then the electronic message is communicated to the mobile device (operation 508) without adding the protection header to the electronic message. In one embodiment, the electronic message may be communicated to the mobile device via a network. For example, the electronic message may be delivered to an electronic mail message box of the mobile device.

In another embodiment, the electronic message may be communicated to the mobile device wirelessly. For example, the electronic message may be pushed to the mobile device using cellular communications. In another example, the electronic message may be sent to the mobile device using a Bluetooth© protocol. In still another example, the electronic message may be sent to the mobile device using a wireless Internet protocol. In this way, received electronic messages that contain predetermined data may be identified and flagged with a protection header before they are sent to the mobile device.

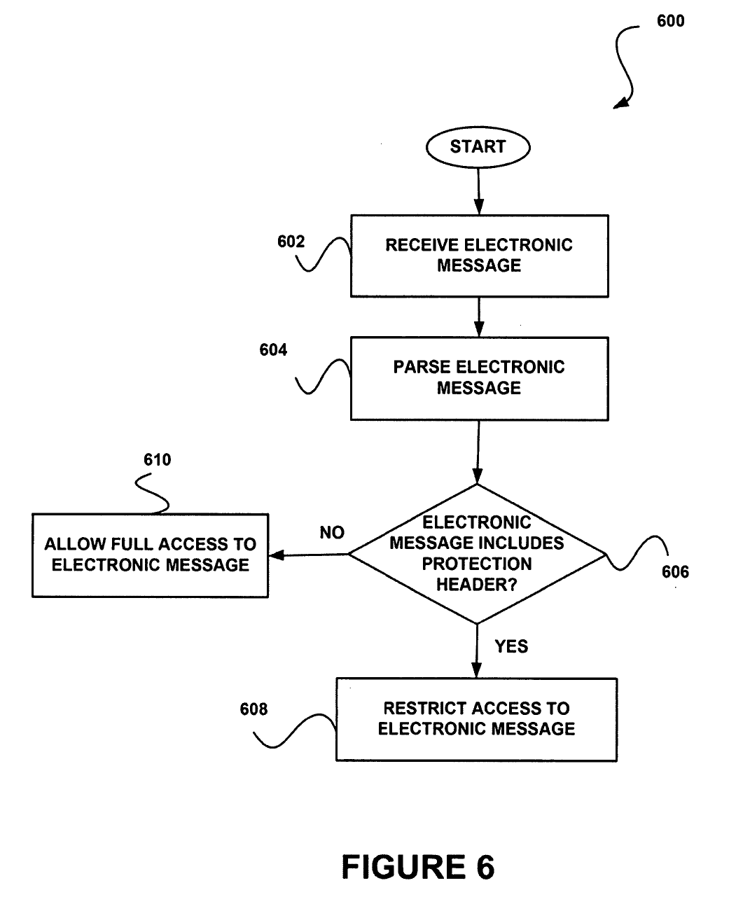

FIG. 6 shows a method 600 for conditionally restricting access to an electronic message, in accordance with yet another embodiment. As an option, the method 600 may be carried out in the context of the architecture and environment of FIGS. 1-5. For example, the method 600 may be carried out utilizing the mobile device 406 of FIG. 4. Of course, however, the method 600 may be carried out in any desired environment. Again, it should be noted that the aforementioned definitions may apply during the present description.

As shown in operation 602, an electronic message is received. For example, the electronic message may be received from a security system. As another option, the electronic message may be received over a network. Additionally, the electronic message is parsed. See operation 604. In one embodiment, the parsing may include analyzing one or more portions of the electronic message. For example, the parsing may include identifying headers of the electronic message.

Further, in decision 606 it is determined whether the electronic message includes a protection header. In one embodiment, the headers of the electronic message may be compared against predetermined protection headers. In another embodiment, one or more keywords included in the headers of the electronic message may be compared to a list and/or database of predetermined keywords. Accordingly, a match may indicate that the electronic message includes a protection header.

If it is determined in decision 606 that the electronic message does not include the protection header, then in operation 610 full access to the electronic message is allowed. In one embodiment, allowing full access may include allowing one or more actions to be performed on the electronic message. For example, allowing full access may include enabling deletion of the electronic message, modification of the electronic message, viewing of the electronic message, etc.

In another embodiment, allowing full access may include enabling the transfer of the electronic message. For example, allowing full access may include allowing forwarding of the electronic message through an electronic message system. In another example, allowing full access may include allowing transfer of the electronic message through the use of a Bluetooth© protocol. In still another example, allowing full access may include allowing transfer of the electronic message through the use of an SMS protocol.

If, however, it is determined in decision 606 that the electronic message includes the protection header, then in operation 608 access to the electronic message is restricted. In the context of the present embodiment, restricting access may include limiting any aspect of otherwise full access to the electronic message. Optionally, the types of access restrictions may be based on information included in the protection header. In one embodiment, restricting access may include limiting transfer of the electronic message. For example, if it is determined that the electronic message includes the protection header, a user may be unable to send or forward all or some of the electronic message.

In another embodiment, restricting access may include limiting the actions that can be performed on the electronic message. For example, if it is determined that the electronic message includes the protection header, the user may be unable to save or print all or some of the electronic message. In this way, the transfer of the received electronic message may be controlled based on the existence of the protection header, thereby preventing leakage of predetermined data.

While various embodiments have been described above, it should be understood that they have been presented by way of example only, and not limitation. For example, any of the network elements may employ any of the desired functionality set forth hereinabove. Thus, the breadth and scope of a preferred embodiment should not be limited by any of the above-described exemplary embodiments, but should be defined only in accordance with the following claims and their equivalents.

What is claimed is:

1. A method, comprising:
receiving an electronic message;
determining whether the electronic message includes a predetermined data structure, wherein the predetermined data structure includes a header indicating that the electronic message contains predetermined data for which associated network transmissions are to be managed;
comparing the header of the electronic message against one or more predetermined data structures in a database, the one or more predetermined data structures indicative of the header including confidential information; and
conditionally restricting an aspect of the electronic message based on a determination of whether the header of the electronic message includes at least one of the one or more predetermined data structures in the database, wherein the header includes information indicating a type of restriction, from among a plurality of different types of restrictions, to be applied to one or more portions of the electronic message during the conditionally restricting.

2. (canceled)

3. (canceled)

4. (canceled)

5. The method as set forth in claim 1, wherein the aspect includes access to at least a portion of the electronic message.

6. The method as set forth in claim 1, wherein the aspect includes a transfer of at least a portion of the electronic message.

7. The method as set forth in claim 1, wherein the aspect includes at least one of communication of an electronic mail message including at least a portion of the electronic message, storage of at least a portion of the electronic message, communication of a text message including at least a portion of the electronic message, and forwarding of at least a portion of the electronic message.

8. The method as set forth in claim 1, wherein the aspect includes at least one of a modification to at least a portion of the electronic message, a display of at least a portion of the electronic message, a deletion of at least a portion of the electronic message, and generation of a copy of at least a portion of the electronic message.

9. The method as set forth in claim 1, wherein the predetermined data structure is added to the electronic message by a data leakage prevention system.

10. The method as set forth in claim 9, wherein the electronic message is received from the data leakage prevention system.

11. The method as set forth in claim 10, wherein the electronic message is received from the data leakage prevention system over a network.

12. The method as set forth in claim 1, wherein the predetermined data structure is added to the electronic message if the electronic message contains predetermined data.

13. The method as set forth in claim 1, wherein the predetermined data structure is added to the electronic message by a data leakage prevention system if the electronic message contains confidential data.

14. The method as set forth in claim 1, wherein the aspect of the electronic message is restricted if it is determined the electronic message includes the predetermined data structure.

15. The method as set forth in claim 1, wherein the aspect of the electronic message is not restricted if it is determined the electronic message does not include the predetermined data structure.

16. The method as set forth in claim 1, wherein the receiving, determining, and conditionally restricting are performed by a mobile device.

17. The method as set forth in claim 1, wherein the receiving, determining, and conditionally restricting are performed by a data leakage prevention system of a mobile device.

18. A computer program product embodied on a tangible non- transitory computer readable medium for performing operations, comprising:
determining whether an electronic message includes a predetermined data structure, wherein the predetermined data structure includes a header indicating that the electronic message contains predetermined data for which associated network transmissions are to be managed;
comparing the header of the electronic message against one or more predetermined data structures in a database, the one or more predetermined data structures indicative of the header including confidential information; and
conditionally restricting an aspect of the electronic message based on a determination of whether the header of the electronic message includes at least one of the one or more predetermined data structures in the database, wherein the header includes information indicating a type of restriction, from among a plurality of different types of restrictions, to be applied to one or more portions of the electronic message during the conditionally restricting.

19. A system, comprising:
a processor, wherein the system is configured for:
receiving an electronic message,
determining whether the electronic message includes a predetermined data structure, wherein the predetermined data structure includes a header indicating that the electronic message contains predetermined data for which associated network transmissions are to be managed,
comparing the header of the electronic message against one or more predetermined data structures in a database, the one or more predetermined data structures indicative of the header including confidential information, and
conditionally restricting an aspect of the electronic message based on a determination of whether the electronic message includes at least one of the one or more predetermined data structures in the database, wherein the header includes information indicating a type of restriction, from among a plurality of different types of restrictions, to be applied to one or more portions of the electronic message during the conditionally restricting.

20. The system as set forth in claim 19, further comprising memory coupled to the processor via a bus.

21. The method as set forth in claim 1, wherein the electronic message is intercepted by a security system during communication of the electronic message from a source.

22. The method as set forth in claim 1, wherein the electronic message is determined to include the predetermined data structure if a match is found between at least the portion of the electronic message and the one or more predetermined data structures.

23. The method as set forth in claim 1, wherein the predetermined data structure includes instructions describing at least one action to take to protect against the data leakage.

24. The method as set forth in claim 1, wherein the one or more predetermined data structures in the database include one or more predetermined headers.
